(19) United States
(12) Patent Application Publication
(10) Pub. No.: US 2025/0323431 A1
(43) Pub. Date: Oct. 16, 2025

(54) METAL SPRING PLATE FOR CONDUCTOR CONNECTION DEVICE

(71) Applicants: SWITCHLAB INC., NEW TAIPEI CITY (TW); SWITCHLAB (SHANGHAI) CO., LTD., SHANGHAI CITY (CN); GAOCHENG ELECTRONICS CO., LTD., SHENZHEN (CN)

(72) Inventors: CHIH YUAN WU, NEW TAIPEI CITY (TW); MING SHAN TAI, NEW TAIPEI CITY (TW)

(21) Appl. No.: 19/098,083

(22) Filed: Apr. 2, 2025

(30) Foreign Application Priority Data
Apr. 15, 2024 (TW) 113203703

(51) Int. Cl. H01R 4/48

(52) U.S. Cl. CPC H01R 4/48

(57) ABSTRACT

A metal spring plate structure for conductor connecting device includes a main body having a base part, a crimp part connected to a first section of the base part for crimping an external conductor, and a locating part connected to a second section of the base part for removably engaging with a conducting component, such that the conducting component and the conductor are electrically connected. A curved section is formed between the first section and the crimp part, and an elongated elevated structure is protruded from an upper or a lower side of the main body. The elongated elevated structure overlaps the crimp part and passes the curved section to extend toward the first section. The metal spring plate provides good structural strength and stable conductor crimping force without becoming deformed or unstable in contact after operating over a long time to ensure good conducting efficiency and safety in use.

### FIELD OF THE INVENTION

The present invention relates to a structural design of a metal spring plate for a conductor connection device, and more particularly, to a metal spring plate structure used with a device to hold down or release a conductor plugged into the device.

### BACKGROUND OF THE INVENTION

It is a known skill of using an electrical connector or metal element (such as a metal spring plate) enveloped in a usually plastic insulation shell to hold down a conductor extended into a connection terminal, so as to form an electrical connection or release of the conductor to or from the connection terminal, such as a terminal device or a crimp terminal.

This type of electrical conductor connection device can be used in many different forms. For example, it can be inserted onto a circuit board, such as a printed circuit (PC) board or be arrayed into rows for clipping onto a ground rail or an electrically conducting rail, so as to construct a ground device common for electronic appliances or mechanical apparatus to be used with different electrical equipment, electronic devices, automatic control equipment, etc. Different forms of electrical conductor connection devices can be assembled to an operational panel, a distribution box, or other similar objects to connect wirings and circuit, and/or to be used in cooperation with push buttons or knobs for controlling circuit wiring or to serve as a switch device for electrically connecting or disconnecting one or more conductors.

Some typical examples can be seen in CN 102204015A disclosing an electrical connection terminal; US 2014/0127932 A1 disclosing an electrical connection terminal; U.S. Pat. No. 5,362,259 disclosing a ground conductor terminal; U.S. Pat. No. 6,627,830B2 disclosing a push button and teaching pendant with the push button; etc.

The electrical connection device normally includes an insulation shell provided with through holes or wire entry holes that allow conductors to be plugged into the shell. The shell internally defines a chamber, in which conducting components, electrical connectors or metal spring plates are assembled for contacting or electrically connecting with the conductors plugged into the shell. The electrical connectors respectively include an elastic free end or crimping end, which crimps the conductor when the same has been plugged into the shell, preventing the conductor from easily losing contact with the electrical connector and the conducting components. The conductors could not be released from the electrical connectors unless an operator pushes the free end open by extending a tool into the shell.

Another issue in relation to the structural design and application of the above type of metal spring plate for the electrical connection device is how to give the metal spring plate increased conductor crimping stability and strength. Some earlier patents, such as EP 3226351 A1, EP 3226352 A1, DE 20014025 U1, etc., provide embodiments of adding or putting another piece of steel spring plate behind the metal spring plate to increase the force of holding down the conductor.

However, as known by those skilled in the art to which the conductor connection device pertains, the above-mentioned conventional conductor connection device with additional metal spring plates has a relatively complicated structure and involves troublesome assembling procedures. Particularly, the conventional metal spring plate tends to deform after it is used over a long time or is operated frequently. In the worse condition, material fatigue or breaking would undesirably occur at locations of the metal spring plate that are bent frequently.

Generally, the above-mentioned patents indicate the disadvantageous conditions of the conventional metal spring plate, the conventional electrical connection device, or other relevant connecting components in the use and structural design thereof. However, these disadvantages can be eliminated or improved by considering the structure and manner of use of the metal spring plate from different ways, so as to change the form and effect of using the metal spring plate for the conductor connection device.

For example, based on the premise of having simple structure and easy operation, an ideal structural form of a metal spring plate should satisfy the following key points: (a) having a structure capable of providing better structural strength and stable holding-down force than the conventional ones without increasing the number or material thickness of the metal spring plate and/or the conducting components; and (b) being capable of overcoming the conditions of deformation, material fatigue, breaking, failure due to external factors, including impacting, pulling, etc., to ensure good electrical conduction and safety in use of the metal spring plate even when it has been used over a long time or operated highly frequently.

All these key points were not taught or specifically disclosed in the above-mentioned earlier inventions.

### SUMMARY OF THE INVENTION

A primary object of the present invention is to provide a metal spring plate structure for conductor connection device that has improved structural strength and provides stable conductor crimping force. The metal spring plate structure according to the present invention includes a main body that has a base part defining a first section and a second section; an elastic crimp part connected to the first section of the base part for crimping an external conductor; and a locating part connected to the second section of the base part for assembling to a conducting component, such that the conducting component and the conductor are electrically connected. A curved section is formed between the first section and the crimp part; and at least one elongated elevated structure is provided on the main body. The elongated elevated structure overlaps at least a part of the crimp part and passes at least a part of the curved section to extend toward the first section. With these arrangements, the metal spring plate structure of the present invention can overcome the disadvantages of the conventional metal spring plate, including the occurrence of deformation, material fatigue, breaking, and instable contact with the conductor, that lead to inefficient electrical conduction and less safe for use.

According to the metal spring plate structure for conductor connection device according to the present invention, the elongated elevated structure can be upward or downward protruded from the main body. Further, an area between the main body and one or both of two lateral sides of the elongated elevated structure can be a hollow-out area or a connection wall.

### BRIEF DESCRIPTION OF THE DRAWINGS

FIG. 1 is a perspective view of a metal spring plate structure for conductor connection device according to a first embodiment of the present invention and a conducting component to be used therewith;

FIG. 2 is an assembled structural view of FIG. 1;

FIG. 3 is a sectional side view of FIG. 2;

FIG. 4 is a perspective view of a metal spring plate structure for conductor connection device according to a second embodiment of the present invention, wherein areas at two lateral sides of an elongated elevated structure are connection walls;

FIG. 5 is a sectional side view of FIG. 4;

FIG. 6 is a perspective view of a metal spring plate structure for conductor connection device according to a third embodiment of the present invention, wherein areas between two lateral sides of an elongated elevated structure and a main body of the metal spring plate structure are hollow-out areas;

FIG. 7 is a sectional side view of FIG. 6;

FIG. 8 is a perspective view of a metal spring plate structure for conductor connection device according to a fourth embodiment of the present invention, wherein an elongated elevated structure is protruded from a lower side of a main body of the metal spring plate structure;

FIG. 9 is a sectional side view of FIG. 8;

FIG. 10 is a perspective view of a metal spring plate structure for conductor connection device according to a fifth embodiment of the present invention, wherein an elongated elevated structure is protruded from an upper side of a main body of the metal spring plate structure and formed with an elongated opening;

FIG. 11 is a sectional side view of FIG. 10;

FIG. 12 is a perspective view of a metal spring plate structure for conductor connection device according to a sixth embodiment of the present invention, wherein an elongated elevated structure is protruded from a lower side of a main body of the metal spring plate structure and formed with an elongated opening; and

FIG. 13 is a sectional side view of FIG. 12.

### DETAILED DESCRIPTION OF THE PREFERRED EMBODIMENTS

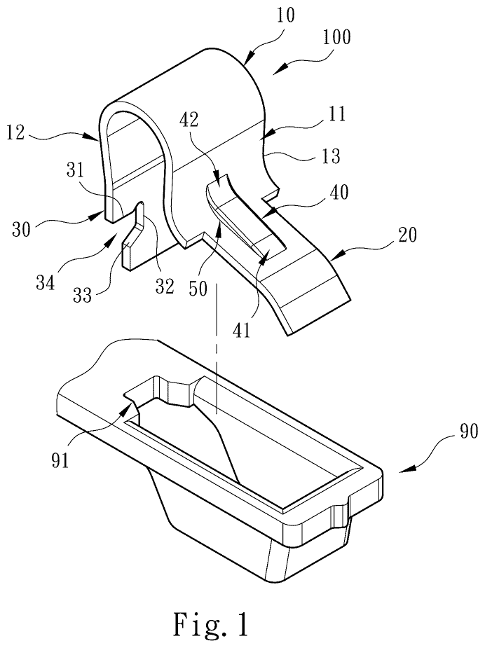

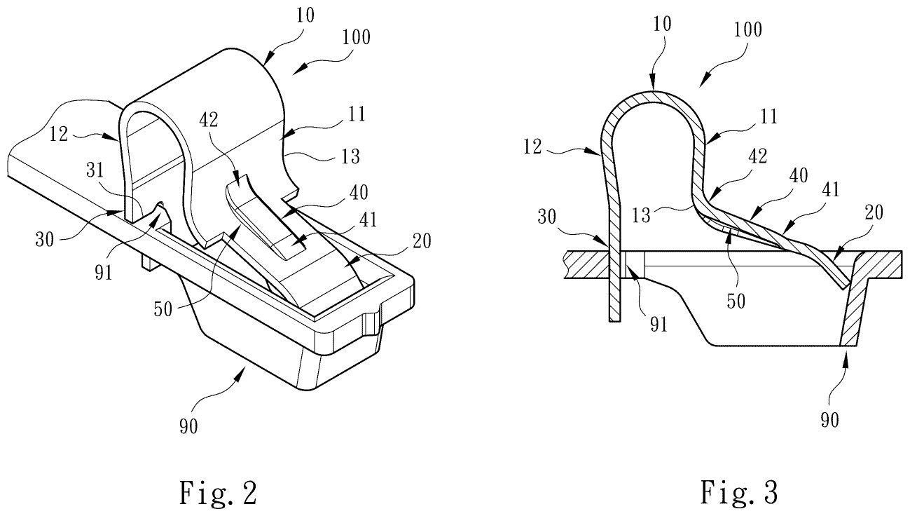

Please refer to FIGS. 1, 2, and 3. The present invention relates to a metal spring plate structure for conductor connection device, which includes a main body generally denoted by reference numeral 100. The main body 100 can be assembled to a conducting component 90 for crimping an external conductor, such that the conducting component 90 and the conductor are electrically connected. Since this part is already known, it is not described in detail herein.

It is noted directions viewed in front of the drawings are determined as reference directions for the directional terms of upper end (or section), lower end (or section), left side, right side, front end (or section), rear end (or section), lateral side, etc. being used in the present invention.

As shown in the drawings, the main body 100 includes a base part 10 that has an inverted U-shaped curved configuration. The base part 10 defines a first section 11 and a second section 12. The first section 11 is connected to an elastic crimp part 20 of the main body 100 for crimping the external conductor; and the second section 12 is connected to a locating part 30 of the main body 100 for assembling to the conducting component 90.

Specifically, the locating part 30 includes a shoulder section 31, a neck section 32 connected to the shoulder section 31, and a secondary section 33 connected to the neck section 32; and the shoulder section 31, the neck section 32, and the secondary section 33 together define a notch 34 for removably engaging with or located at a locating area 91 on the conducting component 90.

FIGS. 1, 2, and 3 depict a curved section 13 formed between the first section 11 and the crimp part 20. An elongated elevated structure 40 is provided on the main body 100 to occupy at least a partial area of the crimp part 20 and pass at least the curved section 13 to extend toward the first section 11.

Specifically, the elongated elevated structure 40 is a long strip that defines a first end 41 and a second end 42. The first end 41 is connected with the crimp part 20 and the second end 42 is connected with the base part 10, or the first section 11, or the curved section 13.

In a first embodiment of the present invention, as shown in FIGS. 1 to 3, the elongated elevated structure 40 is protruded from an upper side of the main body 100 (i.e. protruded upward when viewing in front of the drawings) with a hollowed-out area (or gap) 50 formed between the elongated elevated structure 40 and the curved section 13 and the crimp part 20 of the main body 100.

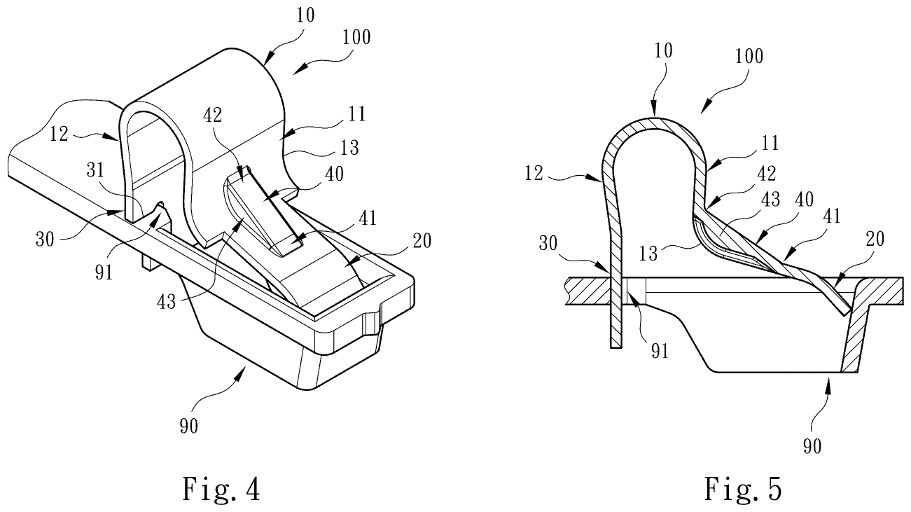

Please refer to FIGS. 4 and 5, which are perspective view and sectional side view, respectively, of a metal spring plate structure according to a second embodiment of the present invention. In the second embodiment, the elongated elevated structure 40 is protruded from the upper side of the main body 100 (i.e. protruded upward when viewing in front of the drawings) with two connection walls 43 formed between two lateral sides of the elongated elevated structure 40 and the curved section 13 or the first section 11 and the crimp part 20 of the main body 100.

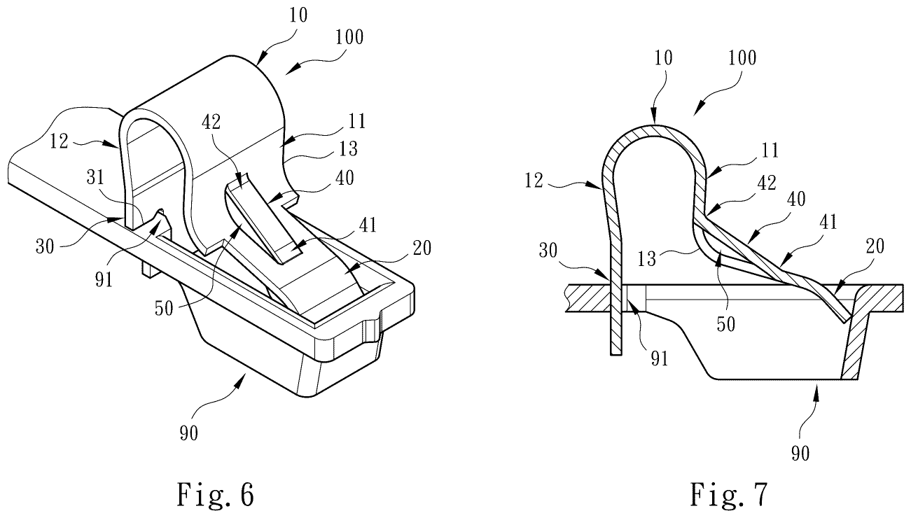

FIGS. 6 and 7 show a third embodiment of the present invention, in which the elongated elevated structure 40 is protruded from an upper side of the main body 100 (i.e. protruded upward when viewing in front of the drawings) with a hollow-out area formed between the elongated elevated structure 40 and the curved section 13 or the first section 11 and the crimp part 20 of the main body 100.

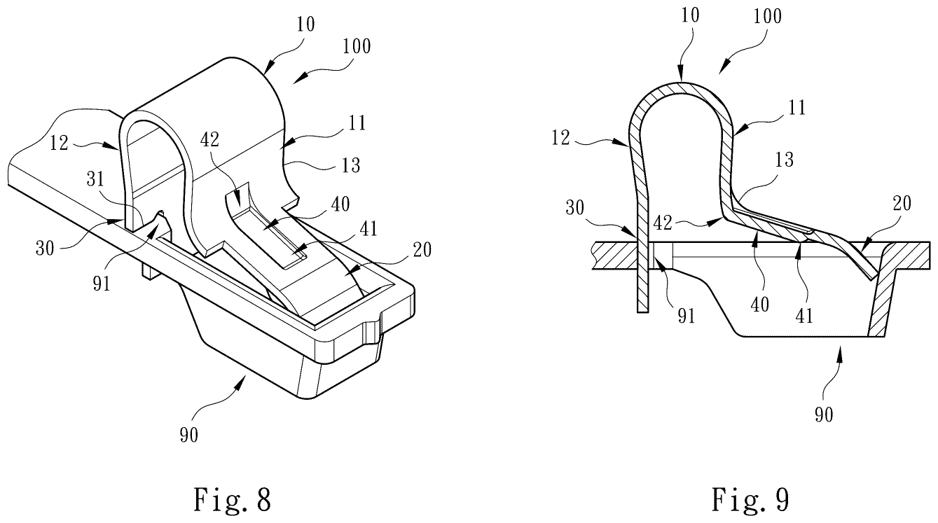

FIGS. 8 and 9 show a fourth embodiment of the present invention, in which the elongated elevated structure 40 is protruded from a lower side of the main body 100 (i.e. protruded downward when viewing in front of the drawings) to form a long strip-like recess with two lateral sides of the elongated elevated structure 40 connected to the curved section 13 or the first section 11 and the crimp part 20 of the main body 100.

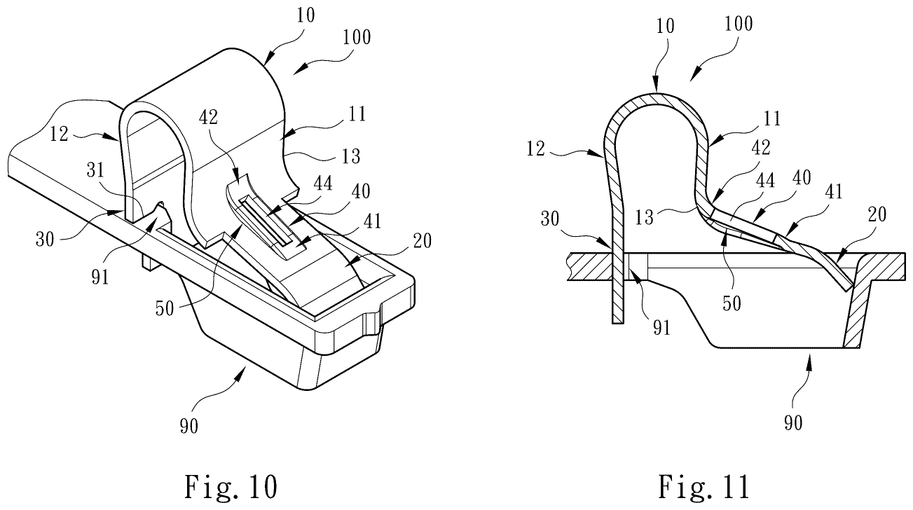

Please refer to FIGS. 10 and 11, which depict a fifth embodiment of the present invention. In the fifth embodiment, the elongated elevated structure 40 protrudes from an upper side of the main body 100 (i.e., protruding upward when viewing in front of the drawings) with an elongated opening 44 formed on the elongated elevated structure 40.

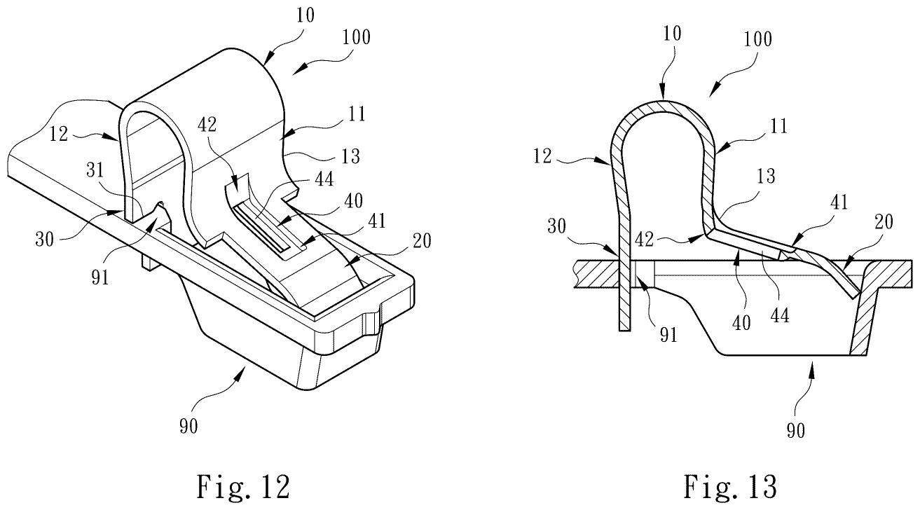

Please refer to FIGS. 12 and 13, which show a sixth embodiment of the present invention. In the sixth embodiment, the elongated elevated structure 40 is protruded from a lower side of the main body 100 (i.e. protruded downward when viewing in front of the drawings) to form a long strip-like recess with two lateral sides of the elongated elevated structure 40 connected to the curved section 13 or the first section 11 and the crimp part 20 of the main body 100. Further, an elongated opening 44 is formed on the elongated elevated structure 40.

It can be found that the elongated elevated structure 40 can be easily formed to protrude upward or downward from the main body 100 (i.e. to protrude from an upper or a lower side of the main body 100 when viewing in front of the drawings) and used as a reinforcing structure between the curved section 13 and the crimp part 20 and/or the base part 10. With the elongated elevated structure 40, it is able to overcome the disadvantages of the conventional metal spring plate that is easily subjected to deformation, material fatigue, breaking and instable contact when being used over a long time or being operated frequently to result in reduced conducting efficiency and safety in use.

Compared to the conventional metal spring plate, the improved metal spring plate structure according to the present invention satisfies the requirements of easy manufacturing and/or operation while taking the following into consideration, and gets the following advantages:

(1) The main body 100 and other cooperating structures are redesigned to provide an elongated elevated structure 40, which is extended from the first section 11 of the base part 10 to the crimp part 20 while passing the curved section 13. The elongated elevated structure 40 has a first end 41 connected with the crimp part 20 and a second end 42 at least passing and connecting with the curved section 13 and/or the first section 11 of the main body 100. The gaps between the two lateral sides of the elongated elevated structure 40 and the main body 100 can be hollowed-out areas 50 or connection walls 43. This design is obviously different from the conventional metal spring plate structure and provides the metal spring plate structure of the present invention with a different use and operational manner.

(2) Particularly, under the premise of not increasing the quantity or the material thickness of the metal spring plate and/or the conducting component, the present invention has a structure capable of providing better structural strength and stable hold-down force than the conventional metal spring plate and overcomes the adverse conditions of deformation, material fatigue or breaking due to being used frequently or over a long time, or due to externally factors, such as impact or pull resulted from man-made negligence, that would lead to bad conducting efficiency and safety in use.

Therefore, the metal spring plate structure of the present invention is improved and can be effectively used with a conductor connection device to overcome the disadvantages in the conventional metal spring plate. Therefore, the metal spring plate structure of the present invention meets the requirement for granting a patent.

The present invention has been described with some preferred embodiments thereof, and it is understood that many changes and modifications in the described embodiments can be carried out without departing from the scope and the spirit of the invention that is intended to be limited only by the appended claims.

What is claimed is:

1. A metal spring plate structure for a conductor connection device, comprising a main body (100), which includes a base part (10), a crimp part (20), and a locating part (30); and an elongated elevated structure (40);
the base part (10) defining a first section (11) and a second section (12); and the first section (11) being connected to the crimp part (20) and the second section (12) being connected to the locating part (30) with a curved section (13) formed between the first section (11) and the crimp part (20);
the elongated elevated structure (40) being provided on the main body (100) and defining a first end (41) and a second end (42); the elongated elevated structure (40) overlapping at least a part of the crimp part (20) and passing at least the curved section (13) to extend toward the first section (11); and the elongated elevated structure (40) provided on the main body (100) at a position selected from the group consisting of protruding from an upper side of the main body (100) and protruding from a lower side of the main body (100); and
an area between at least one lateral side of the elongated elevated structure and the main body being one of a hollowed-out area (50) and a connection wall (43).

2. The metal spring plate structure for a conductor connection device as claimed in claim 1, wherein the main body (100) is assembled to a conducting component (90); the base part (10) being in the form of an inverted U-shaped curved structure; the locating part (30) including a shoulder section (31), a neck section (32) connected to the shoulder section (31), and a secondary section (33) connected to the neck section (32); and the shoulder section (31), the neck section (32) and the secondary section (33) together defining a notch (34) on the locating part (30) for removably engaging with a locating area (91) of the conducting component (90).

3. The metal spring plate structure for a conductor connection device as claimed in claim 1, wherein the elongated elevated structure (40) is in the form of a long strip with the first end (41) thereof connected to the crimp part (20) and the second end (42) thereof connected to at least one of the first section (11) and the curved section (13) of the main body (100); and the elongated elevated structure (40) being provided on the main body (100) at the position of protrusion from the upper side of the main body (100), and the area between each of two lateral sides of the elongated elevated structure (40) and at least the curved section (13) and the crimp part (20) of the main body (100) being a hollow-out area (50).

4. The metal spring plate structure for a conductor connection device as claimed in claim 2, wherein the elongated elevated structure (40) is in the form of a long strip with the first end (41) thereof connected to the crimp part (20) and the second end (42) thereof connected to at least one of the first section (11) and the curved section (13) of the main body (100); and the elongated elevated structure (40) being provided on the main body (100) at the position of protrusion from the upper side of the main body (100), and the area between each of two lateral sides of the elongated elevated structure (40) and at least the curved section (13) and the crimp part (20) of the main body (100) being a hollow-out area (50).

5. The metal spring plate structure for a conductor connection device as claimed in claim 1, wherein the elongated elevated structure (40) is provided on the main body (100) at the position of protrusion from the upper side of the main body (100), and the area at each of two lateral sides of the elongated elevated structure (40) being a connection wall (43) connected to at least the curved section (13) and the crimp part (20) of the main body (100).

6. The metal spring plate structure for a conductor connection device as claimed in claim 2, wherein the elongated elevated structure (40) is provided on the main body (100) at the position of protrusion from the upper side of the main body (100), and the area at each of two lateral sides of the elongated elevated structure (40) being a connection wall (43) connected to at least the curved section (13) and the crimp part (20) of the main body (100).

7. The metal spring plate structure for a conductor connection device as claimed in claim 1, wherein the elongated elevated structure (40) is provided on the main body (100) at the position of protrusion from the lower side of the main body (100) to form a long strip-like recess; and the two lateral sides of the elongated elevated structure (40) being connected to at least the curved section (13) and the crimp part (20) of the main body (100).

8. The metal spring plate structure for a conductor connection device as claimed in claim 2, wherein the elongated elevated structure (40) is provided on the main body (100) at the position of protrusion from the lower side of the main body (100) to form a long strip-like recess; and the two lateral sides of the elongated elevated structure (40) being connected to at least the curved section (13) and the crimp part (20) of the main body (100).

9. The metal spring plate structure for a conductor connection device as claimed in claim 1, wherein the elongated elevated structure (40) is provided on the main body (100) at the position of protrusion from the upper side of the main body (100) and has an elongated opening (44) formed thereon.

10. The metal spring plate structure for a conductor connection device as claimed in claim 2, wherein the elongated elevated structure (40) is provided on the main body (100) at the position of protrusion from the upper side of the main body (100) and has an elongated opening (44) formed thereon.

11. The metal spring plate structure for a conductor connection device as claimed in claim 3, wherein the elongated elevated structure (40) has an elongated opening (44) formed thereon.

12. The metal spring plate structure for a conductor connection device as claimed in claim 4, wherein the elongated elevated structure (40) has an elongated opening (44) formed thereon.

13. The metal spring plate structure for a conductor connection device as claimed in claim 5, wherein the elongated elevated structure (40) has an elongated opening (44) formed thereon.

14. The metal spring plate structure for a conductor connection device as claimed in claim 6, wherein the elongated elevated structure (40) has an elongated opening (44) formed thereon.

15. The metal spring plate structure for a conductor connection device as claimed in claim 7, wherein the elongated elevated structure (40) has an elongated opening (44) formed thereon.

16. The metal spring plate structure for a conductor connection device as claimed in claim 8, wherein the elongated elevated structure (40) has an elongated opening (44) formed thereon.
